(19) United States
(12) Patent Application Publication
(10) Pub. No.: US 2001/0054655 A1
(43) Pub. Date: Dec. 27, 2001

(54) CLEANING DEVICE

(76) Inventors: ROLAND BERG, BAD DITZENBACH (DE); HANS-CLEMENS STEFFEL, REICHENBACH (DE); HELMUT HAF, SCHWAIKHEIM (DE); WOLFGANG ROBEL, FILDERSTADT-SIELMINGEN (DE)

Correspondence Address: ROBERT W BECKER & ASSOCIATES, 11896 N HIGHWAY 14, SUITE B, TIJERAS, NM, 87059

(21) Appl. No.: 09/371,885

(22) Filed: Aug. 9, 1999

(30) Foreign Application Priority Data
Aug. 7, 1998 (DE) 198 35 773.8

(51) Int. Cl. B05B 1/10

(52) U.S. Cl. 239/284.1; 239/346; 239/351; 239/369

(57) ABSTRACT

A cleaning device has a tank for liquid and a conveying device as well as an outlet opening. A conduit is connected to the tank and to the outlet opening. The conveying device is connected to the conduit and introduces a compressed gas into the conduit so that the cleaning medium exiting from outlet opening is a mixture of the liquid contained in the tank and the compressed gas.

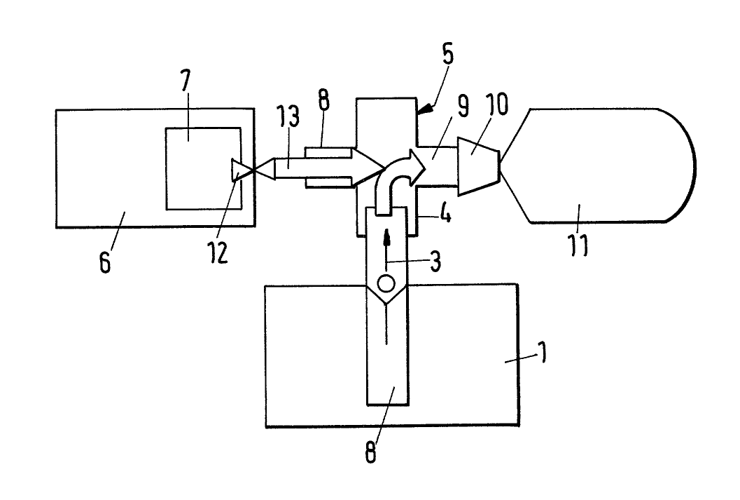

### BACKGROUND OF THE INVENTION

The present invention relates to a cleaning device, especially for vehicle parts, such as lights, mirrors, window panes, etc., the device comprising a conveying device with which, via at least one line, a cleaning medium contained in at least one container is supplied to an outlet opening.

It is known to provide for cleaning soiled headlights a cleaning device which sprays water onto the headlight glass. The water is conveyed via a line by a pump to the outlet spray nozzle which is positioned in front of the headlight. The liquid spray pre-soaks the soiled portion and the soil deposit is then removed by the wiper which is arranged in front of the headlight. The windshield as well as the back window of the vehicle can also be cleaned by such cleaning devices in conjunction with wipers.

Furthermore, devices are known which apply a cleaning liquid at high pressure onto the surface to be cleaned without carrying out a subsequent wiping step.

A disadvantage of such cleaning devices is that the vehicle must be provided with a relatively large liquid container which increases the weight of the vehicle. Also this has the disadvantage that for heavy soiling it is not ensured in every situation that the dirt particles are removed in a satisfactory manner.

It is therefore an object of the present invention to provide a cleaning device of the aforementioned kind that allows removal of dirt present on vehicle parts in a simple, inexpensive, and reliable manner.

### SUMMARY OF THE INVENTION

This object is inventively solved for a cleaning device of the aforementioned kind by providing a cleaning medium which is a mixture of a liquid and a compressed gas.

With the inventive embodiment, the cleaning medium is sprayed at high pressure onto the surface to be cleaned so that the dirt particles under the effect of the compressed gas/liquid mixture are initially pre-soaked and then subsequently removed in a simple manner by the impinging spray. By employing a compressed gas/liquid mixture, the water consumption of the inventive cleaning device is considerably reduced so that less cleaning liquid must be stored in the vehicle. This has the advantage that the weight of the vehicle is reduced and the energy consumption of the vehicle is also lowered. Since the dirt can be relatively easily removed by the mixture applied at high pressure and since the dirt can be completely removed, the proper function of the vehicle parts to be cleaned can be simply and completely restored in a very short period of time. This ensures high safety of the vehicle in traffic because the surface to be cleaned regains quickly its full functionality. For example, optical systems, lights, such as headlights or taillights, can be easily cleaned so that the vehicle in traffic can be easily detected at any point in time. The inventive cleaning device is also suitable for cleaning mirrors, window panes, and other vehicle parts. Since the inventive cleaning device requires less liquid for the cleaning action then conventional cleaning devices, it is also possible to use relatively thin supply lines which is also beneficial with regards to cost savings.

### BRIEF DESCRIPTION OF THE DRAWING

The object and advantages of the present invention will appear more clearly from the following specification in conjunction with the accompanying only drawing showing the inventive cleaning device in a schematic representation.

### DESCRIPTION OF PREFERRED EMBODIMENTS

The present invention will now be described in detail with the aid of a specific embodiment utilizing the only FIGURE.

The drawing shows a liquid tank 1 into which a line 2 projects. The line 2 accommodates a shut-off valve 3, preferably, a check valve, that closes toward the liquid tank 1. The line 2 is connected to an arm 4 of a housing 5 in an area outside the tank 1. For conveying the liquid from the tank 1 to the spray nozzle 10, a conveying device 6 is provided which is a compressor. It contains also an intermediate pressure container 7 and is connected to a further arm 8 of the housing 5. A line 9 provides a connection from the housing 5 to the spray nozzle 10 (outlet opening) via which the cleaning medium 11 is dispensed. Thus, the line 2, the housing 5, and the line 9 form a conduit for the liquid.

The compressor 6 produces compressed air which is stored in the intermediate pressure or storage container 7. By actuating the valve 12, the intermediate pressure or storage container 7 and the shut-off valve 3 are opened so that compressed air can flow in the direction of arrow 13 through the arms 8 and 9 to the spray nozzle 10. The high flow velocity of the compressed air produces vacuum in the housing 5 by which the liquid is sucked in from the tank 1 according to the venturi principle and is mixed with the compressed air. The resulting compressed gas/liquid mixture 11 exits from the nozzle 10 and impinges at high pressure onto the surface to be cleaned. The surface may be the glass of a headlight, a mirror, a window pane, or an optical system etc. of the vehicle. In addition, wipers can be arranged in front of the respective vehicle part to enhance the cleaning action. The gas/water mixture impinges on the dirt particles of the surface to be cleaned so that they are pre-soaked and then removed. Subsequently, by closing the shut-off valve 3, the liquid supply can be interrupted so that only compressed air will impinge on the surface to be cleaned. This results in drying of the cleaned surface.

It is also possible to supply the gas/water mixture in a pulsating manner onto the surface to be cleaned. This improves removal of dirt particles that adhere strongly to the surface.

The cleaning device can also be embodied such that the compressor 6 is connected to the liquid tank 1, respectively, the line or hose 2 so that water is forced under high pressure into the housing 5. In this case, the venturi effect results in a vacuum sucking in air which is then mixed with the pressurized water to the gas/water mixture 11.

The cleaning process can be started automatically or manually. For example, behind the glass of the vehicle headlight sensors may be arranged which determine the degree of soiling of the glass and produce a signal upon surpassing a pre-set soiling limit that results in activation of the cleaning device. Instead of this automatic actuating device, it is also possible to provide a switch at the dash board of the vehicle with which the cleaning device can be manually operated.

After the vehicle part has been cleaned in the afore described manner, it can now fulfill its designated function, for example, a taillight can now again produce the required light output. This increases the safety of the vehicle in traffic because the vehicle, even under most unfavorable weather conditions, can be detected within the shortest amount of time, after actuation of the cleaning device, by other traffic participants, and the driver will have unimpaired vision in a very short period of time by having the windshield or lights cleaned.

Since the disclosed cleaning device operates with a relatively minimal amount of liquid, respectively, water, the weight of the vehicle and thus the required energy for operating the vehicle is considerably reduced. The cleaning effect of the disclosed cleaning device can be further improved when the surface to be cleaned has a coating that improves beading of the cleaning liquid.

The specification incorporates by reference the disclosure of priority document DE 198 35 733.8 of Aug. 7, 1998.

The present invention is, of course, in no way restricted to the specific disclosure of the specification and drawings, but also encompasses any modifications within the scope of the appended claims.

What is claimed is:

1. A cleaning device comprising:
a tank (1) for a liquid;
a conveying device (6, 7);
an outlet opening (10);
a conduit (2, 5, 9) connecting said tank (1) to said outlet opening (10);
said conveying device (6, 7) connected to said conduit (2, 5, 9) or said tank (1) for conveying the liquid to said outlet opening (10) and producing a cleaning medium (11) exiting from said outlet opening (10) as a mixture of the liquid contained in said tank and a gas.

2. A device according to claim 1, wherein said conveying device (6, 7) comprises a compressor generating a compressed gas.

3. A device according to claim 1, wherein the gas is a compressed gas and wherein the liquid and the compressed gas are mixed according to the venturi principle.

4. A device according to claim 3, wherein the compressed gas is compressed air and wherein the liquid is water.

5. A device according to claim 1, comprising a means for shutting off liquid flow to said spray nozzle (10).

6. A device according to claim 5, wherein said means is a shut-off valve (3) positioned in said conduit (2, 5, 9).

7. A device according to claim 6, wherein said shut-off valve (3) shuts off the flow of liquid for performing a drying step after cleaning with the cleaning medium (11).

8. A device according to claim 1, wherein said conduit (2, 5, 9) comprises a housing (5), a connecting line (2) connecting said tank (1) to said housing (5) and a connecting line (9) connecting said housing (5) to said outlet opening (10), wherein said conveying device (6, 7) is connected to said housing (5).

9. A device according to claim 8, wherein said conveying device (6, 7) comprises a compressor (6) and an intermediate storage container (7) for producing and storing compressed gas, wherein said shut-off valve (12) is mounted at an outlet of said intermediate storage container (7).

10. A device according to claim 9, wherein said conveying device (6, 7) has a shut-off valve (12) for controlling the flow of compressed gas.

11. A device according to claim 8, wherein the compressed gas is compressed air flowing at high pressure through said housing (5) to said outlet opening (10) and generating a vacuum for sucking the liquid from said tank (1) into said housing (5).

12. A device according to claim 1, wherein said outlet opening (10) is part of a spray nozzle.

13. A device according to claim 1, comprising an automatic actuating device.

14. A device according to claim 1, comprising a manual actuating device.
